(19) United States
(12) Patent Application Publication
(10) Pub. No.: US 2007/0073675 A1
(43) Pub. Date: Mar. 29, 2007

(54) DATABASE QUERY TRANSLATION

(75) Inventors: Cyril Kaar, Co Kildare (IE); Andrej Doba, Dublin 15 (IE)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 11/532,933

(22) Filed: Sep. 19, 2006

(30) Foreign Application Priority Data
Sep. 24, 2005 (EP) 0519555.7

(51) Int. Cl. G06F 17/30

(52) U.S. Cl. 707/4

(57) ABSTRACT

A method of translating a relational database query from a first format to a second format comprises receiving a query in a first format, converting the query into a text-only document, processing the text-only document according to predefined rules to create an amended text-only document, copying the amended text-only document into a predefined template, and outputting from the template a query in a second format. The processing of the text-only document according to predefined rules can comprise deleting non-instruction material from the text-only document and/or changing the variable syntax throughout the text-only document.

### BACKGROUND OF THE INVENTION

This invention relates to a method of translating a relational database query, to a data processing system for translating a relational database query, and to a computer program product on a computer readable medium.

Within many large corporations, data mining and reporting is key to knowledge management, control systems and general day-to-day operations. The storage of large amounts of electronic data is commonly achieved using relational databases. These databases store vast numbers of records, each composed of a series of fields storing data. Such databases are used for data such as employee details, customer records, project details, financial records etc. Software is normally associated with a database for the purpose of updating and querying records. Users can access individual records by simple requests, but all advanced databases support the use of complicated queries that relate to multiple fields and use Boolean logic. Over time the software used with databases has developed to include the creation of Structured Query Language (SQL), which supports complicated querying of relational databases. A very large number of highly specialised queries exist in SQL, which represent many thousands of hours of time of specialist software engineers.

Modern data management tools are being developed which have more user-friendly GUIs (Graphical User Interfaces) than older SQL-based tools. Often these modern tools tend to use visual format relational database queries rather than SQL. Following the development of these more modern database systems, the ability to translate database queries from one format (such as SQL) to another format is highly desirable. This would allow the integration of the huge store of SQL queries with the modern functionality, and would save the enormous effort involved in re-creating all the reports and queries that have been developed over the last 20 or so years in SQL.

U.S. Pat. No. 5,428,737 discloses a comprehensive bilateral translation between SQL and graphically depicted queries. This Patent discloses a method, system and program providing comprehensive bilateral translation between text format and visual format relational database queries. In a preferred form, tables and lists are configured to define a common data structure. Translation between SQL query statements and the common data structure is accomplished. Similarly, a common data structure for the visual or graphical format queries is defined, preferably employing graphics symbols and multiple windows. Bidirectional translation is thereafter accomplished through the common data structure.

The disclosure in this document is to a system that can translate an SQL query into a graphical representation of the query and vice versa. The principal purpose of this is to render already existing queries easier to understand by a non-specialist user and to facilitate the creation of SQL queries by such a user. A graphical user interface is provided that uses common graphical interface techniques such as selection from menus and drag-and-drop of elements to simplify the amendment and creation of SQL queries. However, the system does not provide any disclosure of how to translate a query into a different format that would be used by a different database system. The graphically depicted query is merely the same SQL query shown graphically, and is not a translation into a different format.

### SUMMARY OF THE INVENTION

It is therefore an object of the invention to improve upon the known art.

According to a first aspect of the present invention, there is provided a method of translating a relational database query from a first format to a second format comprising receiving a query in a first format, converting the query into a text-only document, processing the text-only document according to predefined rules to create an amended text-only document, copying the amended text-only document into a predefined template, and outputting from the template a query in a second format.

According to a second aspect of the present invention, there is provided a data processing system for translating a relational database query from a first format to a second format comprising a processor arranged to receive a query in a first format, to convert the query into a text-only document, to process the text-only document according to predefined rules to create an amended text-only document, to copy the amended text-only document into a predefined template, and to output from the template a query in a second format.

According to a third aspect of the present invention, there is provided a computer program product on a computer readable medium comprising instructions for translating a relational database query from a first format to a second format comprising receiving a query in a first format, converting the query into a text-only document, processing the text-only document according to predefined rules to create an amended text-only document, copying the amended text-only document into a predefined template, and outputting from the template a query in a second format.

### BRIEF DESCRIPTION OF THE DRAWINGS

Embodiments of the present invention will be described with reference to the accompanying drawings.

FIG. 1 is a schematic diagram of a data processing system.

FIG. 2 is a flow diagram of a method of translating a relational database query.

FIG. 3 is a flow diagram of a portion of the method of translating a relational database query.

FIGS. 4 to 12 are screenshots of a display device of the data processing system of FIG. 1.

### DETAILED DESCRIPTION OF THE INVENTION

Owing to the invention, it is possible to provide a method and system for converting a query in one format to a query in a second format.

Advantageously, the step of processing the text-only document according to predefined rules to create the amended text-only document comprises deleting non-instruction material from the text-only document and changing the variable syntax throughout the text-only document. By deleting non-instruction material, such as headers, footers, comments, quotation marks and line breaks from the text-only document, any material in the original query that will not be understood by the use of the query in a different format will be removed.

Preferably, the template includes a query section. The step of copying the amended text-only document into the predefined template includes changing the query syntax in the query section. The template, which can be specific to the target format, will ensure that as the translation process occurs, the data needed in the query in the target format will be arranged in the right way and have the correct syntax.

Ideally, the first format is a form of SQL, such as IBM's Query Management Facility (QMF™), the second format is Brio Query, and the template is created in JavaScript. Brio Query Explorer, also known as Hyperion Intelligence, is a Windows™-based graphic data mining and reporting tool, owned by Hyperion Solutions Corporation, and widely referred to as ‘Brio’. JavaScript refers to Netscape's cross-platform, object-based scripting language for client and server applications. (Windows is a trademark of Microsoft Corporation. IBM, QMF, OS/390, Lotus, and Word Pro are trademarks of International Business Machines Corporation. Other company, product, or service names may be trademarks or service marks of others.)

Preferred embodiments of the invention thus support the conversion of a QMF query into a Brio Query Explorer document. Following translation the full functionality of Brio can be applied to the QMF statement. This allows enterprises to utilize their vast stores of QMF queries rather than having to rewrite them, and thus enables both time and cost savings.

The combination of these two approaches addresses some of the limitations in Brio, for example, in relation to nested queries, which are sometimes not practical to create in Brio, due to their complexity. In this respect, QMF is more practical. Likewise OS/390® Server level calculations in Brio have a limit on the number of calculations that can be performed simultaneously, which QMF does not.

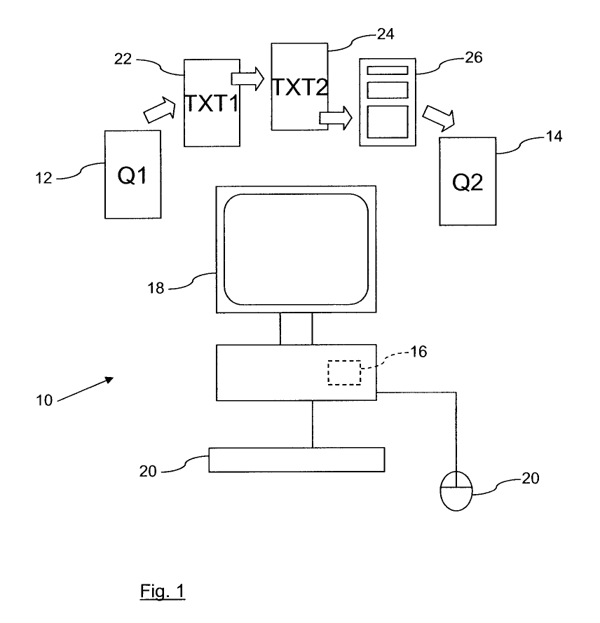

FIG. 1 shows a data processing system 10 for translating a relational database query 12 in a first format to a query 14 in a second format. The system includes a processor 16, a display device 18 and user interface devices 20. The data processing system 10 is arranged to receive the query 12 in its first format, and to convert the query 12 into a query 14 in a second format via a series of intermediate steps. The conversion process can be completely automatic, with the first query 12 being received and the system 10 simply outputting the transformed query 14, or user input can be used at different stages of the process to modify the process or to make decisions on how the transformation takes place. The function of the original query 12 is maintained in the new query 14, which can now be used in a new environment, while taking advantage of the intellectual effort used in the creation of the original query 12.

The processor 16 is arranged to extract a statement 12 from a source database and to convert that original query 12 into a text-only document 22. The processor 16 will then process the text-only document 22 according to predefined rules to create an amended text-only document 24. This can involve the use of a text editor to ensure that the original query 12 is cleaned of non-instruction material such as comments, headers, footers and line breaks, and the text editor can be used to modify variable fields. Finally, the processor 16 is arranged to copy the amended text-only document 24 into a predefined template 26, and to output from the template 26 the query 14 in the second format.

In the preferred example embodiment, the format of the query 12 is IBM's QMF, which uses SQL statements to extract and report data from the database, the second format is a Brio Query, and the template is a JavaScript template. Using a JavaScript template the amended text-only document 24 is copied and embedded into the template 26. The query 14 can then be run in, for example, Brio and all the functionality within Brio is available.

The processor 16 uses the JavaScript function of Brio and discovered nests the amended query within a JavaScript template and then process this in Brio resulting the full functionality of both applications being available. This allows a QMF query 12 to be transformed into a Brio query 14.

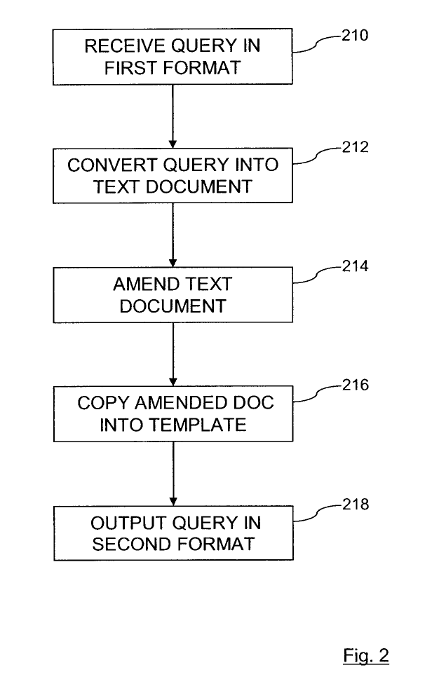

FIG. 2 summarises the method carried out by the system 10. The method, which is for translating the query 12 in a first format to a query 14 in a second format comprises the steps of receiving 210 the query 12 in the first format, converting 212 the query 12 into the text-only document 22, processing 214 the text-only document 22 according to predefined rules to create an amended text-only document 24, copying 216 the amended text-only document 24 into the predefined template 26, and outputting 218 from the template 26 the query 14 in the second format.

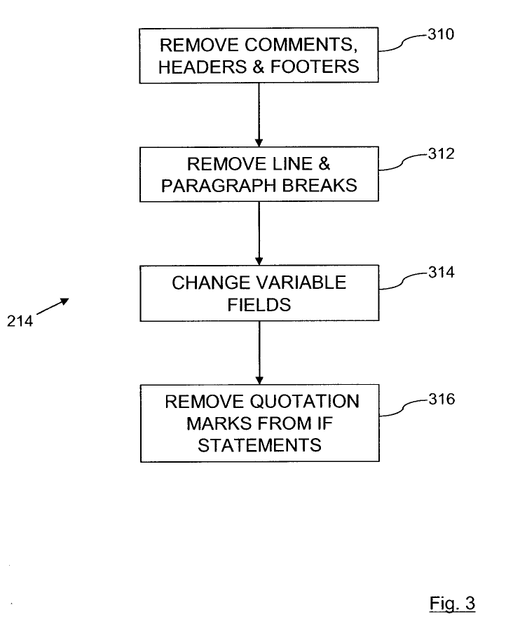

The step 214 of processing the text-only document 22 according to predefined rules to create an amended text-only document 24 includes deleting non-instruction material from the text-only document 22 and changing the variable syntax throughout the text-only document 22. This is summarised in FIG. 3, which shows one example of the actions executed by the processor 16 when the text-only document 22 is being amended.

The actions in FIG. 3 are the steps 310 of removing comments, headers and footers from the text-only document 22, the step 312 of removing line breaks, the step 314 of changing the variable syntax throughout the documents and the step 316 of removing quotation marks from the IF statements in the document 22. The details of these steps are appropriate in a QMF to Brio transformation, for other formats the processing may comprise different actions. The actions shown in FIG. 3 are explained in more detail below, with reference to the Figures showing screen shots of the display device 18 of the system 10.

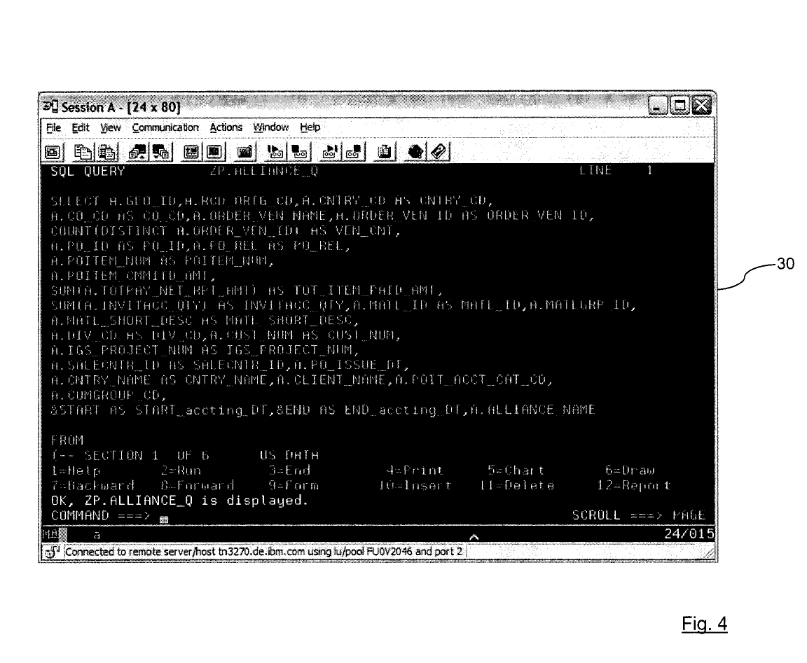

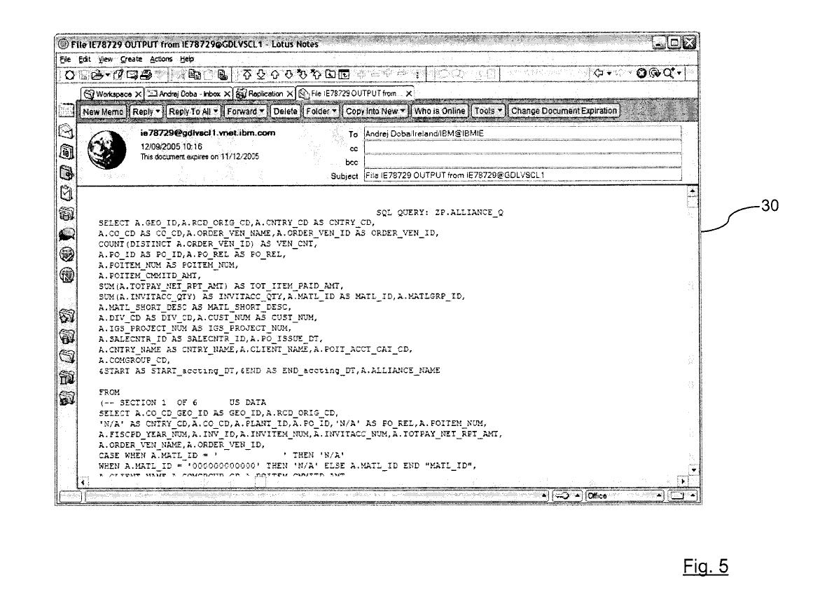

FIG. 4 shows a screen shot 30 of the display device 18, once the first step of receiving a query 12 has been carried out. This step involves locating the desired query 12 in the QMF (Query management system) and sending it to an e-mail client to be available in text form. This step uses the QUERY, SETDEST, and PRINT functions in QMF. For the purposes of the example shown in FIGS. 4 to 12, the query 12 called ZP.ALLIANCE_Q query will be used. This query when printed is close to fourteen pages long, and illustrates the level of complexity that is present in a very large number of QMF queries. After the query 12 is printed and sent to an e-mail inbox it may look like the screen shot 30 of FIG. 5. In this format the script of the query 12 can be easily copied into a word processor for further adjustment.

Once the step 212 of converting the query 12 into a text-only document 22 has been completed, then the step 214 of processing the text-only document 22 can begin. In this example IBM's Lotus® Word Pro® is used as the word processor. In this example, as per FIG. 3, the first substep in the amendment of the text-only document 22 is the step 310 of removing comments, headers and footers.

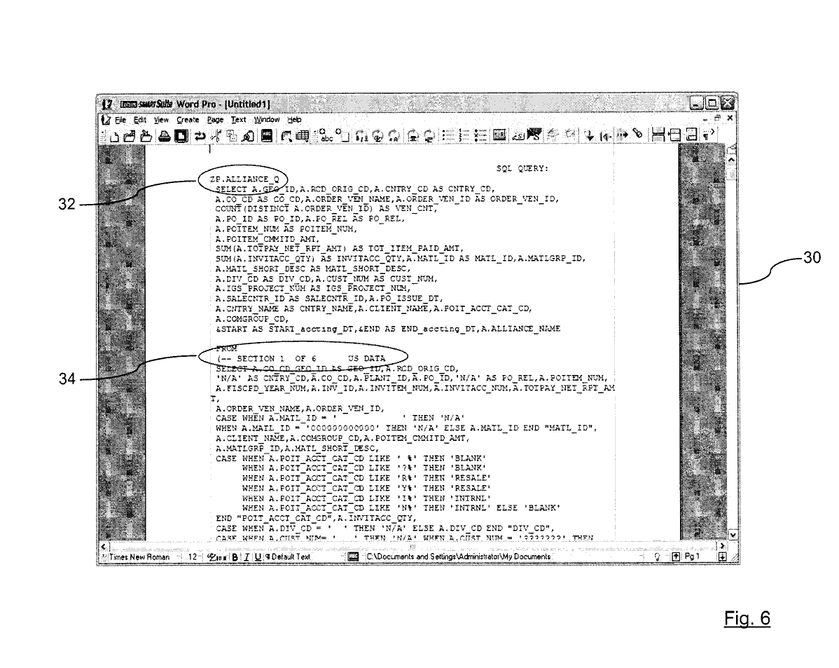

FIG. 6 shows the document 22 before any amendment has taken place. In QMF a comment is identified by two dashes (--). All comments in the document 22 have to be deleted. Comment 34, (-- SECTION 1 OF 6 US DATA), is an example of such a comment that will be removed. Headers include the name of a query and they are all removed as well as the footers that indicate date and time of printing and page numbers. An example of a header 32 is shown in FIG. 6 (SQL QUERY: ZP.ALLIANCE_Q), and this will be removed. An example of a footer (not shown) would be (2005-09-12 05.18.15 PAGE 1).

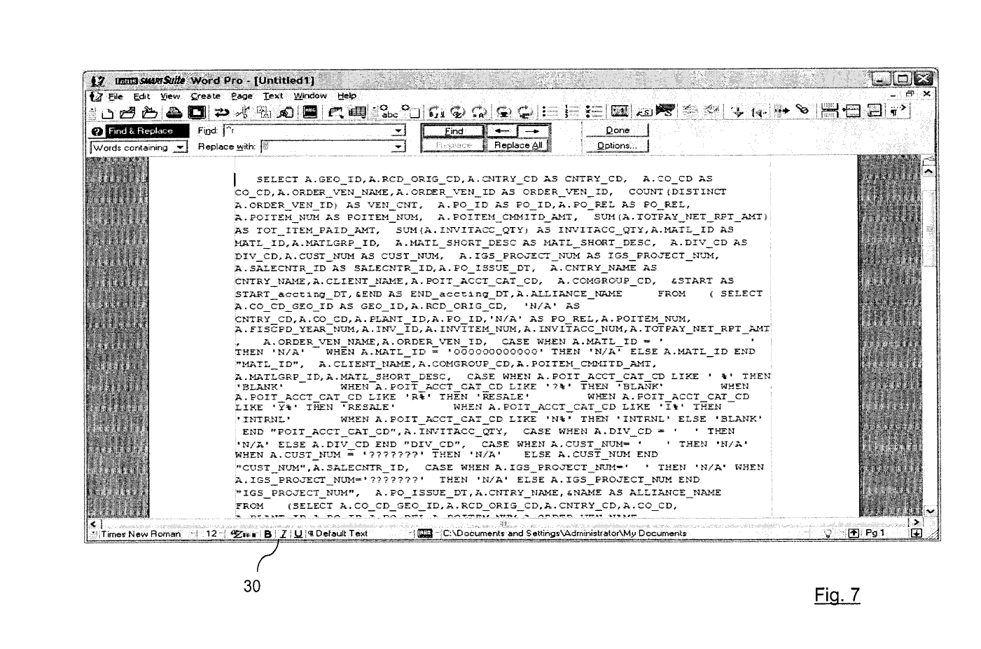

The query statement has to be represented by a text without line or paragraph breaks. At step 312, the second substep in the amendment of the text-only document 22, the removal of the line and paragraph breaks in the document is executed. In Word Pro this step can be easily done by using the find & replace function where line breaks are represented by “ˆr” and replaced by a space. This step produces a text of the amended document 24 similar to the one shown in FIG. 7.

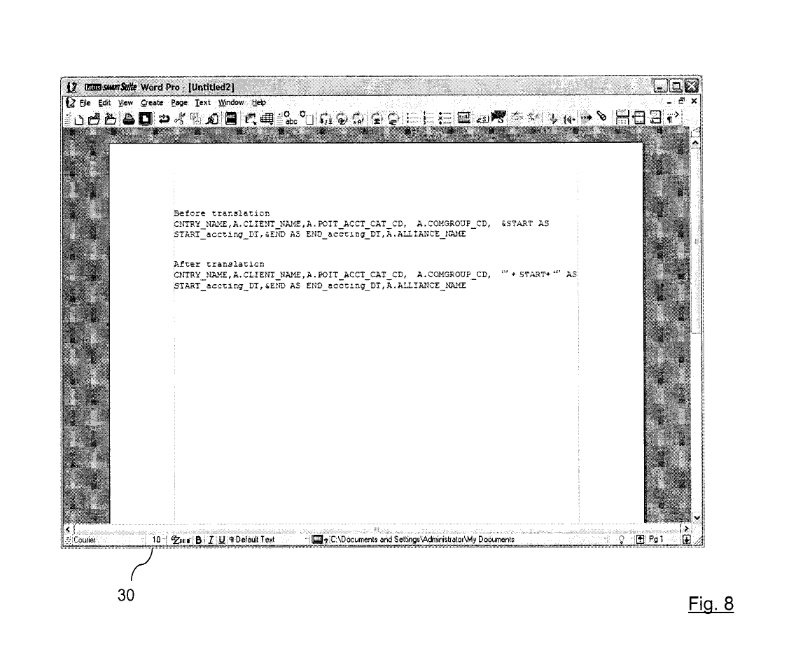

Following the removal of the line and paragraph breaks, a parsing of the document 24 is required to change the syntax of the variables in the document 24. The changing of the variable fields is the execution of the step 314 of FIG. 3. To execute this step, in a QMF to Brio transformation, then the following formula has to be used. The QMF variable syntax of &variable must be changed in each instance in the document 24 to the Brio specific variable syntax of ‘” +variable+“’. FIG. 8 shows a sample of the document 24 before and after the variable syntax has been changed. The variable “START” has had its syntax changed from &START (as in QMF) to ‘” +START+“’ (Brio). This is repeated through the document 24.

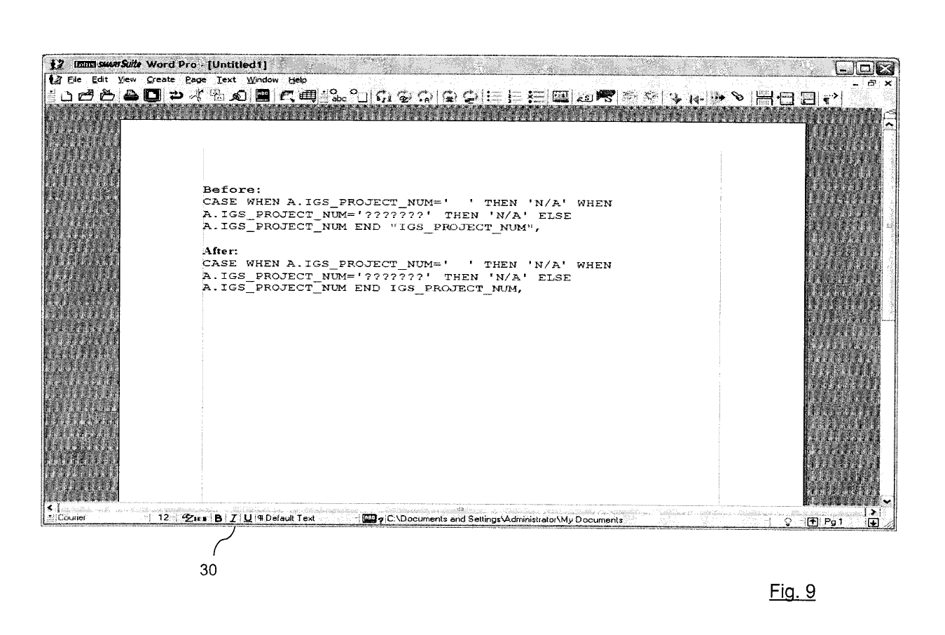

The final step in the amendment phase of the process is the modification of the IF statements (step 316 in FIG. 3). Owing to the fact that Brio uses a slightly different dialect of SQL when compared to QMF, the IF statements in the document 24 have to be modified by removing quotation marks. FIG. 9 shows a sample of the document 24 before and after the quotation marks have been changed.

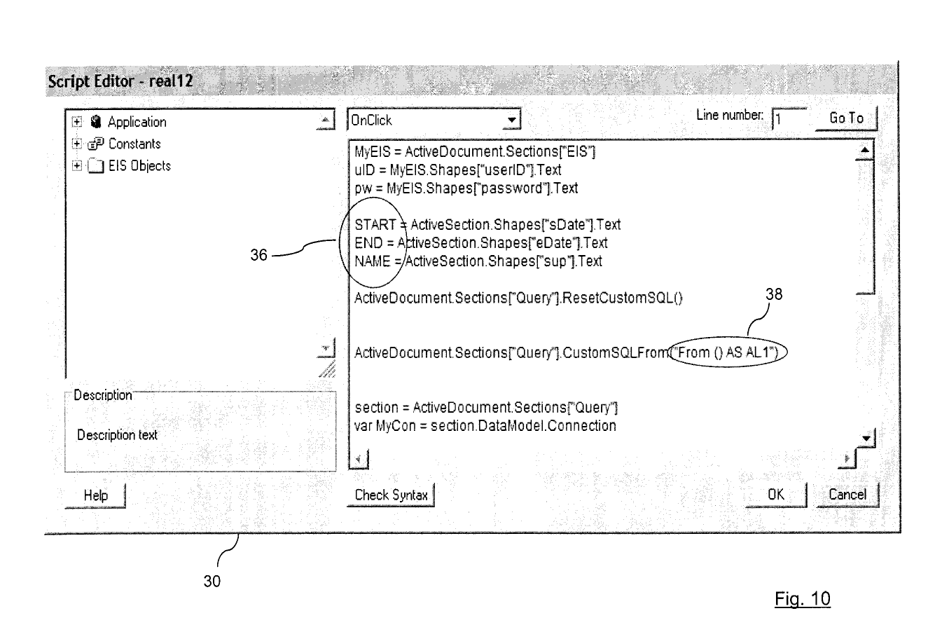

Once the amendment of the document has been completed to give the final amended text-only document 24, then the whole query script has to be copied as one paragraph into the JavaScript Brio template 26. FIG. 10 shows a screen shot 30 of the template 26. The text of the JavaScript template 26 is as follows:

```
  MyEIS = ActiveDocument.Sections[“EIS”]
  uID = MyEIS.Shapes[“userID”].Text
  pw = MyEIS.Shapes[“password”].Text
  START = ActiveSection.Shapes[“sDate”].Text
  END = ActiveSection.Shapes[“eDate”].Text
  NAME = ActiveSection.Shapes[“sup”].Text
  ActiveDocument.Sections[“Query”].ResetCustomSQL( )
  ActiveDocument.Sections[“Query”].CustomSQLFrom(“From (--the
script goes here--) AS AL1”)
  section = ActiveDocument.Sections[“Query”]
  var MyCon = section.DataModel.Connection
  try{
  if (MyCon.Connected == true) {
  MyCon.Disconnect( )}
  MyCon.Username = uID
  MyCon.SetPassword(pw)
  MyCon.Connect( )
  section.Process( )
  section.ResetCustomSQL( )
  MyCon.Disconnect( )
  Alert(“Query finished”)
  }
  catch(e){
  Alert(e)
  }
  }
```

The text from the document 24 is then pasted between the brackets in the JavaScript template 30 indicated by the location 38, viz “From (-- the script goes here--) AS AL1”. The number of limits in the Brio interface and Brio JavaScript should match the limits in the query statement. There are three limits used in this example (START, END, and NAME), shown as 36 in FIG. 10.

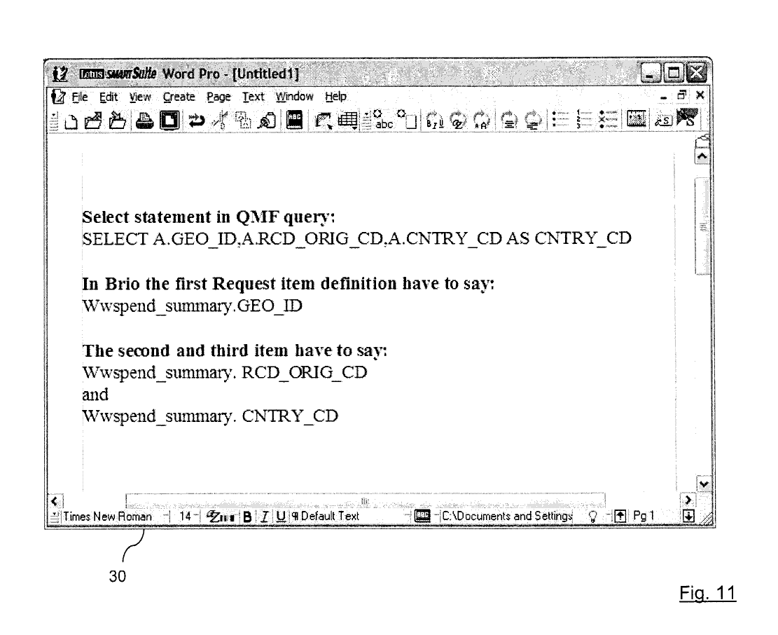

Following copying of the document 24 into the template 26, then the process is ready for termination by the step 218 of outputting the query 14 in the new format. However, in the output phase of the process, further amendment to the query may be needed. In the query section of the QMF to Brio query template the computed items on the request line have to match the fields in the SELECT statement of the QMF query statement. FIG. 11 shows how the query syntax is amended, when the copying into the template 26 takes place.

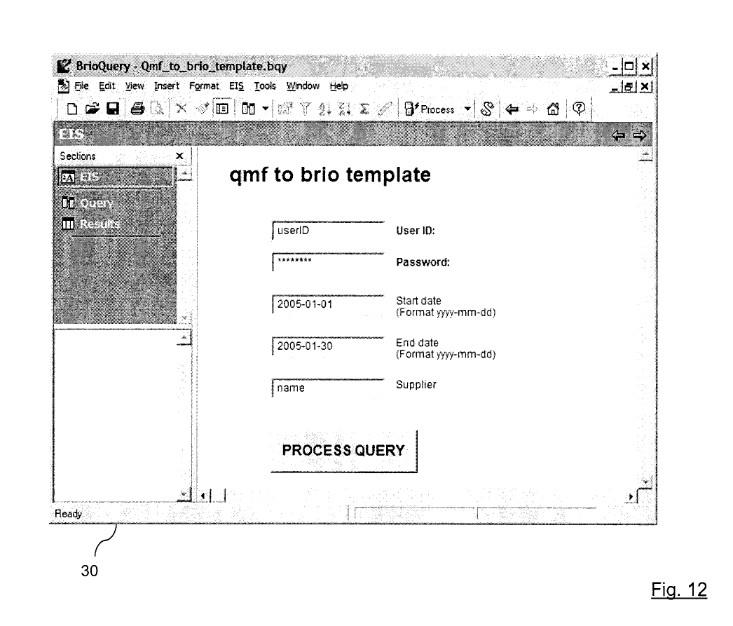

To achieve the output of the query 14, the JavaScript template is created as a .bqy file in the Brio application and can be saved as a new Brio document. The document, which is the new query 14, after entering user id and password and required limits, can be processed in the user-friendly Windows environment, as illustrated by the screenshot 30 in FIG. 12.

The main benefit achieved is by the system for transforming the query from the first format to the second format, is the reduction in development time from weeks to hours. As a general rule, a mid complex to high complex QMF query takes up to 200 hours to build in Brio. It also requires the Brio developer to understand SQL in order to translate it into Brio. This can be reduced to the order of 2 to 4 hours. A number of the limitations of Brio are overcome including that a nested SQL statement will run multiple calculations and the final query also will allow multiple nested SQL statements within itself.

It will be understood by those skilled in the art that, although the present invention has been described in relation to the preceding example embodiments, the invention is not limited thereto and that there are many possible variations and modifications which fall within the scope of the invention.

What is claimed is:

1. A method of translating a relational database query from a first format to a second format comprising receiving a query in a first format, converting the query into a text-only document, processing the text-only document according to predefined rules to create an amended text-only document, copying the amended text-only document into a predefined template, and outputting from the template a query in a second format.

2. A method according to claim 1, wherein the step of processing the text-only document according to predefined rules to create the amended text-only document comprises deleting non-instruction material from the text-only document.

3. A method according to claim 1, wherein the step of processing the text-only document according to predefined rules to create the amended text-only document comprises changing the variable syntax throughout the text-only document.

4. A method according to claim 1, wherein the template is created in JavaScript.

5. A method according to claim 1, wherein the first format is QMF and the second format is Brio.

6. A method according to claim 1, wherein the template includes a query section.

7. A method according to claim 6, wherein the step of copying the amended text-only document into the predefined template includes changing the query syntax in the query section.

8. A data processing system for translating a relational database query from a first format to a second format comprising a processor arranged to receive a query in a first format, to convert the query into a text-only document, to process the text-only document according to predefined rules to create an amended text-only document, to copy the amended text-only document into a predefined template, and to output from the template a query in a second format.

9. A system according to claim 8, wherein the processor is arranged, when processing the text-only document according to predefined rules to create the amended text-only document, to delete non-instruction material from the text-only document.

10. A system according to claim 8, wherein the processor is arranged, when processing the text-only document according to predefined rules to create the amended text-only document, to change the variable syntax throughout the text-only document.

11. A system according to claim 8, wherein the template is created in JavaScript.

12. A system according to claim 8, wherein the first format is QMF and the second format is Brio.

13. A system according to claim 8, wherein the template includes a query section.

14. A system according to claim 13, wherein the processor is arranged, when copying the amended text-only document into the predefined template, to change the query syntax in the query section.

15. A computer program product on a computer readable medium comprising instructions for translating a relational database query from a first format to a second format comprising receiving a query in a first format, converting the query into a text-only document, processing the text-only document according to predefined rules to create an amended text-only document, copying the amended text-only document into a predefined template, and outputting from the template a query in a second format.

16. A computer program product according to claim 15, wherein the step of processing the text-only document according to predefined rules to create the amended text-only document comprises deleting non-instruction material from the text-only document.

17. A computer program product according to claim 15, wherein the step of processing the text-only document according to predefined rules to create the amended text-only document comprises changing the variable syntax throughout the text-only document.

18. A computer program product according to claim 15, wherein the template is created in JavaScript.

19. A computer program product according to claim 15, wherein the first format is QMF and the second format is Brio.

20. A computer program product according to claim 15, wherein the template includes a query section.

21. A computer program product according to claim 20, wherein the step of copying the amended text-only document into the predefined template includes changing the query syntax in the query section.
